(19) United States
(12) Patent Application Publication
(10) Pub. No.: US 2011/0259101 A1
(43) Pub. Date: Oct. 27, 2011

(54) VIBRATION-TYPE FORCE DETECTION SENSOR AND VIBRATION-TYPE FORCE DETECTION DEVICE

(75) Inventor: Kenta SATO, Minowa (JP)

(73) Assignee: SEIKO EPSON CORPORATION, Tokyo (JP)

(21) Appl. No.: 13/089,557

(22) Filed: Apr. 19, 2011

(30) Foreign Application Priority Data
Apr. 21, 2010 (JP) 2010-097611

(51) Int. Cl. G01P 15/10

(52) U.S. Cl. 73/514.29

(57) ABSTRACT

A vibration-type force detection sensor includes: a piezoelectric resonator element provided with a vibration portion and a support portion connected to one end of the vibration portion; and a base which is provided with one main surface which is connected to the support portion and the piezoelectric resonator element is arranged, wherein the piezoelectric resonator element is in a state where the other end side of the vibration portion can oscillate so that the size of a gap between the vibration portion and the one main surface changes when a force acts in a direction which is orthogonal with the one main surface of the base, and is supported in parallel with the one main surface of the base so that an electric equivalent resistance of the vibration portion changes according to the change in the size of the gap.

### BACKGROUND

1. Technical Field

The invention relates to a force detection sensor, and in particular to a vibration-type force detection sensor and a vibration-type force detection device which have a simple configuration and a fast response speed.

2. Related Art

From the past, an acceleration sensor which uses a piezoelectric resonator element has been known. The acceleration sensor which uses a piezoelectric resonator element is configured so that, when a force acts in a detection axial direction on the piezoelectric resonator element, the oscillation frequency of the piezoelectric resonator element changes and the acceleration applied to the acceleration sensor is detected from the change in the oscillation frequency.

In JP-A-2009-271029, an acceleration sensor unit is disclosed. An acceleration sensor unit 101 is provided with a structural body 105 with a rectangular shape and a stress sensitive element 107 as shown in FIG. 11. The structural body 105 with a rectangular shape is provided with a fixing member 110 with a rectangular cuboid shape, a movable member 111 with a rectangular cuboid shape, two parallel long beams 112 and 113 which each have both end portions supported by the fixing member 110 and the movable member 111, and a short beam 114 which has both end portions fixed by intermediate portions of the long beams 112 and 113 and extends in a direction orthogonal to each of the long beams 112 and 113. One upper surface of the fixing member 110 and one upper surface of the movable member 111 are configured to be on the same level. Narrowed portions 115a and 115b are provided at positions at the end edges on the two long beams 112 and 113 which face an up/down surface toward the fixing member 110. When an acceleration α is applied to the structural body 105 from the acceleration detection axial direction, there is a configuration such that the long beams 112 and 113 bend with the narrowed portions 115a and 115b as supports.

The stress sensitive element 107 is provided with stress sensitive portions 120a and 120b and two fixing edges 121 and 122 which are connected to the stress sensitive portions 120a and 120b so as to interpose the stress sensitive portions 120a and 120b.

When the acceleration α is applied in the acceleration detection axial direction to the acceleration sensor unit 101, the movable member 111 receives force in a −Z axial direction due to inertia force and the long beams 112 and 113 of the structural body 105 with a rectangular shape bend (become curved) with the narrowed portions 115a and 115b as supports. Due to the bending of the long beams 112 and 113, elongational stress is added in the stress sensitive portions 120a and 120b via the fixing edge 122 of the stress sensitive element 107 which is joined to the movable member 111 and the oscillation frequency of the stress sensitive element 107 changes. Due to the changing of the frequency of the stress sensitive element 107, it is possible to determine the size and the direction of the applied acceleration.

In addition, in JP-A-2010-32538, a capacitance-type acceleration sensor and a manufacturing method of the same are disclosed. The capacitance-type acceleration sensor is provided with a fixed electrode, amass body which is a movable electrode, and an outer frame portion. The mass body is displaced when acceleration is applied, the gap between the mass body and the fixed electrode changes, and the acceleration sensor detects the change as a change in electrostatic capacitance. The capacitance-type acceleration sensor is formed by using photolithography technology, etching technology, and the like, performing precision processing on a silicon substrate or the like, and using a method such as vacuum deposition.

However, the acceleration sensor unit disclosed in JP-A-2009-271029 is a sensor of a frequency changing type, and while there is an advantage in that there is a lower level of noise due to the digital output, it is necessary that the frequency is counted in the width of gate time and there are problems in that the response time is slow and the current consumption is large. In addition, a master clock is necessary for counting the frequency and there is a drawback in that the acceleration detection device becomes large.

In addition, since the sensitivity of a double tuning fork-type crystal resonator element depends on the width of the vibration arm, there is a problem in that electrode formation becomes difficult when the size is reduced.

In addition, in the capacitance-type acceleration sensor disclosed in JP-A-2010-32538, there is precision processing using photolithography technology, etching technology, and the like, and there is a problem with the yield ratio and there is a problem in that it is easy to have influence from an electric field or static electricity.

### SUMMARY

An advantage of some aspects of the invention is to provide a vibration-type force detection sensor and a vibration-type force detection device which have a simple configuration, a short response time (measurement time) of the force detection, low power consumption, and low cost.

### Application Example 1

According to this application example of the invention, there is provided a vibration-type force detection sensor which is provided with a piezoelectric resonator element provided with a vibration portion where an electrode film is formed on at least one main surface of a piezoelectric substrate and a support portion connected to one end of the vibration portion, and a base which is provided with one main surface which is connected to the support portion and where the piezoelectric resonator element is arranged, where the piezoelectric resonator element is in a state where the other end side of the vibration portion can oscillate so that the size of a gap between the vibration portion and the one main surface changes when a force acts in a direction which is orthogonal with the one main surface of the base, and is supported in parallel with the one main surface of the base so that an electric equivalent resistance of the vibration portion changes according to the change in the size of the gap.

Since the vibration-type force detection sensor is a force detection sensor provided with the base, the piezoelectric resonator element, and a mass portion which is mounted in a free end portion of the piezoelectric resonator element, there are advantages in that the configuration is simple and low costs are possible. An operation is the gap between the piezoelectric resonator element and the base being narrowed due to a force added to the piezoelectric resonator element, and the electric equivalent resistance CI value of the piezoelectric resonator element changing due to an increase in the resistance of gas. Since the applied force is determined by the change in the CI value, there is an effect that the response time (measurement time) is fast compared to a digital-type acceleration sensor. In addition, a counter which measures the frequency is not necessary and it is sufficient if the measurement is intermittent measurement, and there is an effect that power consumption is small and a reduction in size is possible. Furthermore, since it is sufficient if the fixing of the piezoelectric resonator element is fixing at one side, and since there is a lower level of influence of heat expansion due to changes in the temperature of the surroundings, there is an advantage that the detection accuracy is high.

### Application Example 2

According to this application example, the vibration-type force detection sensor is provided with a plurality of the piezoelectric resonator elements, and the piezoelectric resonator elements are provided on the base on each of the one main surface and the other main surface which is at the rear of the one main surface.

Since the vibration-type force detection sensor is configured with the two piezoelectric resonator elements attached and fixed in parallel on both of the main surfaces of the base, when a force which is orthogonal to the base is added, the gaps between each of the piezoelectric resonator elements and the base change so as to be different from each other. That is, when the gap between one of the piezoelectric resonator elements and the base becomes narrower, the gap between the other piezoelectric resonator element and the base changes so as to become wider. Since it is possible to configure a differential operation of the vibration-type force detection sensor, there is an effect that the detection sensitivity of the force is doubled and deterioration due to temperature characteristics or aging can be cancelled out.

### Application Example 3

According to this application example, in the vibration-type force detection sensor of the application example 1 or 2, the piezoelectric resonator element is a double tuning fork-type piezoelectric resonator element which is a pair of parallel vibration arms as the vibration portion, one end of the pair of vibration arms is fixed to the support portion, and the other end of the pair of vibration arms is fixed to the support portion, and a mass portion is arranged in another support portion.

Due to the piezoelectric resonator element using the double tuning fork-type piezoelectric resonator element, the existing manufacturing line using photolithography technology and an etching method can be used. There are advantages that the piezoelectric resonator elements which are currently being produced can be used and a reduction in costs can be achieved. In addition, since it is easy for the flexural vibration to be influenced by the viscosity of gas, there is an effect that the change in the CI value is large and the detection sensitivity of the force is improved.

### Application Example 4

According to this application example, in the vibration-type force detection sensor of the application example 1 or 2, the piezoelectric resonator element is a thickness resonator element.

Due to the piezoelectric resonator element using the thickness resonator element, there is an effect that it is possible to configure the vibration-type force detection sensor which is small in size and superior in temperature characteristics and aging characteristics.

### Application Example 5

According to this application example, in the vibration-type force detection sensor of the application example 1 or 2, the piezoelectric resonator element is a surface acoustic wave resonation element.

Due to the piezoelectric resonator element using the surface acoustic wave resonation element, there is an effect that the supporting of the piezoelectric resonator element is easy and it is possible to mount the mass portion in an arbitrary position where the CI change is large.

### Application Example 6

According to this application example, in regard to the vibration-type force detection sensor of the application example 1 or 2, the piezoelectric resonator element is a gyro element which is provided with a driving vibration arm and a detecting vibration arm for detecting Coriolis force, and the vibration arm is a driving vibration arm.

Due to the piezoelectric resonator element using the vibration gyro element, there is an effect that it is possible to configure a composite sensor where the driving vibration arm detects a force and the detecting vibration arm detects the rotation angular speed of a surface parallel to the base.

### Application Example 7

According to this application example of the invention, there is provided a vibration-type force detection device which is provided with the vibration-type force detection sensor of the application example 1 or 2, an oscillation circuit for oscillating the vibration-type force detection sensor, a filter circuit which attempts to remove a direct current component from an oscillation signal of the oscillation circuit, a rectification circuit which rectifies an output signal from the filter circuit, and an integration circuit which integrates an output signal from the rectification circuit.

By configuring the vibration-type force detection device which is provided with the vibration-type force detection sensor, the oscillation circuit, the filter circuit, the rectification circuit, and the integration circuit, there is an effect that it is possible to configure the device which has a fast response time (measurement time) and a small current consumption, and is small in size at a low cost. In addition, since there is a lower level of influence of heat expansion due to changes in the temperature of the surroundings, there is an advantage that the device is possible where the detection accuracy is high.

### BRIEF DESCRIPTION OF THE DRAWINGS

The invention will be described with reference to the accompanying drawings, wherein like numbers reference like elements.

FIG. 1A is a planar diagram illustrating a configuration of a vibration-type force detection sensor according to a first embodiment, and FIG. 1B is a cross-sectional diagram thereof.

FIGS. 2A to 2C are diagrams describing a double tuning fork-type piezoelectric resonator element, where FIG. 2A is an explanatory diagram of a vibration mode, FIG. 2B is a diagram illustrating an electrode and reference numerals of electric charge generated on the electrode, and FIG. 2C is a connecting diagram of an electrode.

FIGS. 3A and 3B are electric equivalent circuit diagrams of a piezoelectric vibrator.

FIG. 4 is a diagram illustrating a relationship between a gap g and a CI value of the vibration-type force detection sensor.

FIG. 5 is a diagram describing a principle of the invention.

FIG. 6A is a perspective diagram illustrating a configuration of a thickness vibrator, and FIG. 6B is a planar diagram illustrating a configuration of a surface acoustic wave resonator.

FIG. 7 is a planar diagram illustrating a configuration of a vibration gyro.

FIG. 8A is a planar diagram illustrating a configuration of a vibration-type force detection sensor according to a second embodiment, and FIG. 8B is a cross-sectional diagram thereof.

FIG. 9 is a block diagram illustrating a configuration of a vibration-type force detection device.

FIGS. 10A to 10E are diagrams illustrating waveforms of each section shown in the block diagram of FIG. 9.

FIG. 11 is a perspective diagram illustrating a configuration of an acceleration sensor unit of the related art.

### DESCRIPTION OF EXEMPLARY EMBODIMENTS

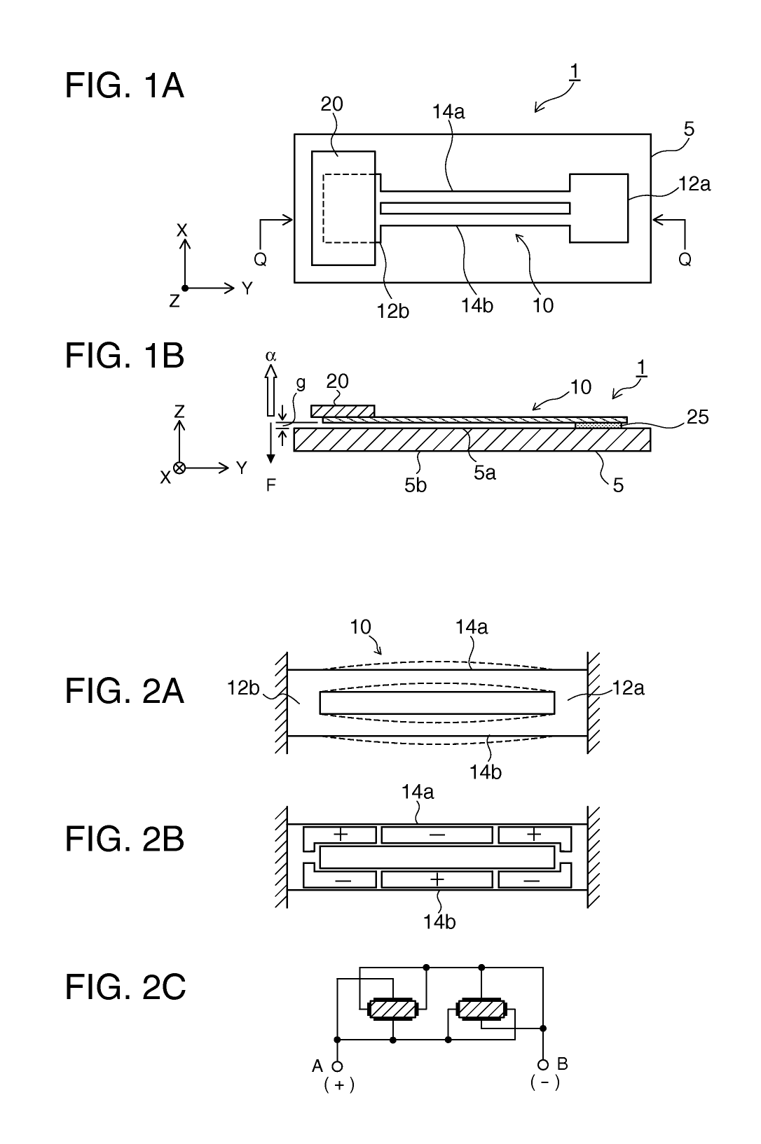

Below, embodiments of the invention will be described in detail based on the diagrams. FIG. 1A is a schematic planar diagram illustrating a configuration of a vibration-type force detection sensor 1 according to a first embodiment of the invention, and FIG. 1B is a cross-sectional diagram along a line Q-Q. The vibration-type force detection sensor 1 is a vibration-type force detection sensor provided with a piezoelectric substrate formed from a quartz crystal substrate or the like, a piezoelectric resonator element 10 where a metallic electrode film is formed on at least one main surface of the piezoelectric substrate, abase 5 which supports the piezoelectric resonator element 10 in a cantilever manner and does not move when a force is added, and a mass portion 20 which is mounted on a free edge portion of the piezoelectric resonator element 10.

The base 5 is a rectangular substrate formed using glass, quartz crystal, or the like, and both of the main surfaces are parallel to each other.

In the case of the embodiment of FIGS. 1A and 1B, the piezoelectric substrate is provided with vibration portions 14a and 14b which flexurally vibrate and support portions 12a and 12b which support each of both end portions of the vibration portions 14a and 14b. The mass portion 20 is mounted on one surface of the support portion 12b which is one of the free edge portions of the piezoelectric substrate by being adhered and fixed using an adhesive or the like. The mass portion 20 is for increasing the detection sensitivity in a case where, for example, acceleration or the like is detected, and a material which has mass and where the mass is not changed due to aging is desirable.

The vibration-type force detection sensor 1 shown in FIGS. 1A and 1B is arranged to be parallel to a Y axial direction which is orthogonal to a force in a Z axial direction which is applied to one main surface 5a of the base 5 and the piezoelectric resonator element 10 is also arranged to be parallel in the Y axial direction. It is desirable if the piezoelectric resonator element 10 is arranged in a direction which is orthogonal to a direction in which a force is added.

The piezoelectric resonator element 10 is supported in a cantilever manner to be parallel to the one main surface 5a of the base 5 via an adhesive 25 which has viscosity so that a gap g between rear surfaces of the vibration portions 14a and 14b and the one main surface 5a of the base 5 changes and an electric equivalent resistance of the piezoelectric resonator element 10 changes when a force (F) acts in the Z axial direction which is orthogonal to the one main surface 5a of the base 5.

The example of the piezoelectric resonator element 10 shown in FIGS. 1A and 1B is a double tuning fork-type crystal resonator element which is formed using photolithography technology and an etching method on a quartz crystal substrate (Z substrate). As shown in FIG. 1A, the double tuning fork-type crystal resonator element 10 is provided with a vibration portion which is formed from the piezoelectric substrate provided with the pair of support portions 12a and 12b and two vibration arms 14a and 14b which are continuously provided between the support portions 12a and 12b, and an excitation electrode formed on a vibration region of the piezoelectric substrate.

FIG. 2A is a planar diagram illustrating a vibration mode of the double tuning fork-type crystal resonator element 10. The excitation electrode is arranged so that the vibration mode of the double tuning fork-type crystal resonator element vibrates in a symmetrical mode with regard to the longitudinal (vibration arm) direction of a central axis. FIG. 2B is a planar diagram illustrating the excitation electrode formed in the double tuning fork-type crystal resonator element 10 and reference numerals of electric charge on the excitation electrode which is excited for a given instant. FIG. 2C is a pattern cross-sectional diagram of connections of the excitation electrode.

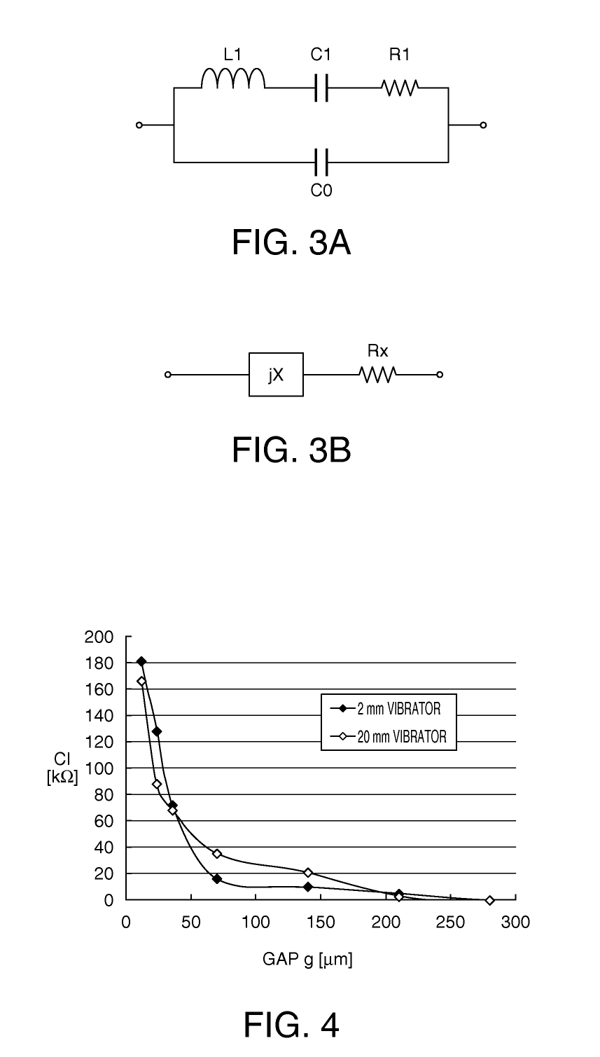

As shown in FIG. 3A, an electric equivalence circuit of the typical piezoelectric vibrator 10 including the double tuning fork-type crystal resonator element is shown as a circuit where electrostatic capacitance C0 is connected in parallel to a serial connection circuit of a motional inductance L1, a motional capacitance C1, and a resistor R1 which represents vibration loss. In addition, as shown in FIG. 3B, the circuit of FIG. 3A equivalently represents a serial connection circuit of reactance jX and resistance Rx, and it is typical that the frequency where the reactance X becomes zero is an oscillation frequency and the resistance Rx at that time is an electric equivalent resistance. In addition, the resistance Rx is also the CI (crystal impedance) and R1 and Rx are substantially the same.

FIG. 4 shows curves which plot changes in CI values measured when a gap g changes in a case where the vibration-type force detection sensor 1 is arranged in air, and the gap g, where the surfaces of the double tuning fork-type crystal resonator element 10 and the base 5 face each other, is set as the horizontal axis and the electric equivalent resistance Rx (CI) of the double tuning fork-type crystal resonator element 10 is set as the vertical axis. The black diamond ♦ curve is a curve of the gap g to electric equivalent resistance Rx (CI) in a case where the length in the longitudinal direction of the double tuning fork-type crystal resonator element 10 is 2 mm (oscillation frequency of 220 kH) and the white diamond ⋄ curve is a curve of the gap g to electric equivalent resistance Rx (CI) in a case where the double tuning fork-type crystal resonator element where the length in the longitudinal direction is 20 mm (oscillation frequency of 40 kH) is used.

When the gap g is large, for example, 300 μm or more, the CI value of the double tuning fork-type crystal resonator element 10 is the normally used vibrator CI value, but it was determined that the CI value becomes larger in accordance with the gap g being equal to or less than 200 μm and the CI value becomes sharply larger when the gap g is equal to or less than 50 μm. In the case of the double tuning fork-type crystal resonator element with a length of 2 mm, the gap g and the CI value substantially have a proportional relationship when the gap g is equal to or less than 70 μm. In addition, in the case of the double tuning fork-type crystal resonator element with a length of 20 mm, the gap g and the CI value substantially have a hyperbolic relationship when the gap g is equal to or less than 200 μm.

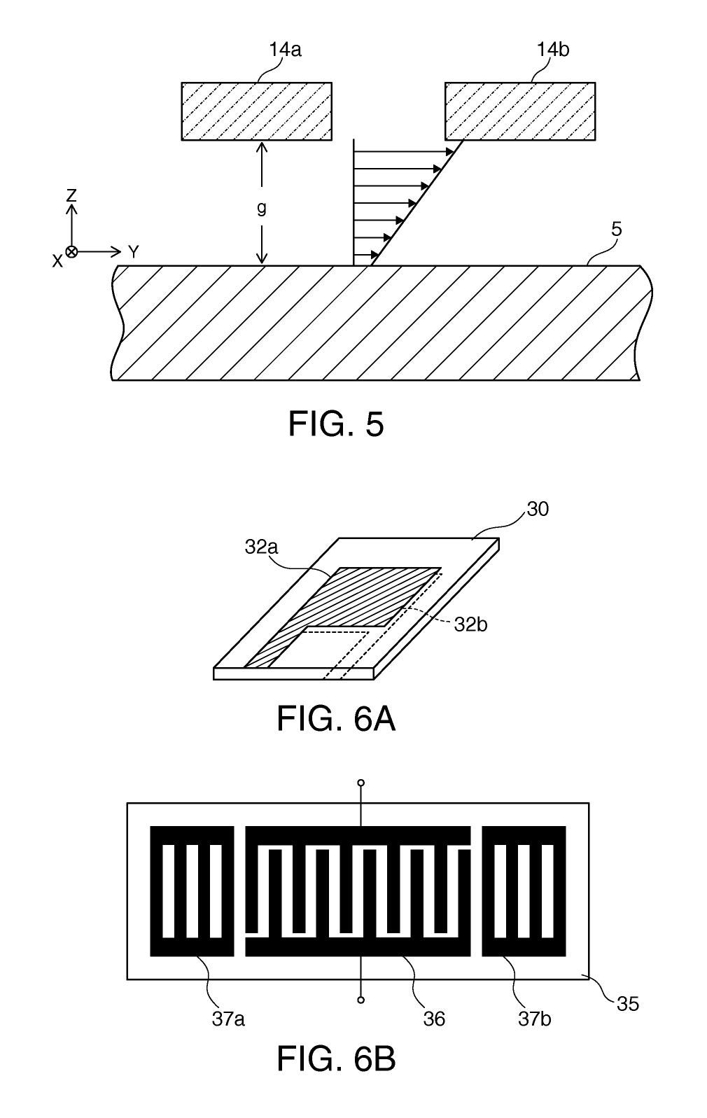

FIG. 5 is a diagram describing a principle of the vibration-type force detection sensor 1 and is a cross-sectional diagram in the X axial direction of the vibration-type force detection sensor 1 shown in FIGS. 1A and 1B. The gap between the vibration arms 14a and 14b of the piezoelectric resonator element (double tuning fork-type piezoelectric resonator element) 10 and the base 5 is set as g, and there are the coordinate axes X, Y, and Z on an upper surface of the base 5. The gap between the piezoelectric vibrator 10 and the base 5 is filled with a gas, for example, air, and the vibration arms 14a and 14b vibrate at a speed U. In the case where the gap g is large, the speed is zero since the gas which is in contact with the base 5 attempts to maintain its position. The shearing deformation speed u of the gas between the base 5 and the vibration arms 14a and 14b is represented by

u=U×z/g (1)

(where z is the position on the Z axis). That is, the gas at a position z from the base 5 is active in a plane parallel to the base 5 at a speed proportional to z.

A force which resists the vibration of the vibration arms 14a and 14b and a force which attempts to stay at the surface of the base 5 are the same, and both are proportional to the speed U and inversely proportional to the gap g. A force τ₀ per unit of area which is in contact with the gas can be represented by differentiating equation (1) and multiplying by the viscosity coefficient μ of the gas as:

τ₀=μ×U/g (2).

That is, the force τ₀ is inversely proportional to the gap g.

When using a typical contoured resonator element such as a tuning fork-type piezoelectric resonator element or a double tuning fork-type piezoelectric resonator element, there are many cases when there it is used in a vacuum to prevent vibration energy from leaking into the gas. The embodiment of the invention uses changes in CI of the piezoelectric vibrator 10 due to the release of vibration energy into the gas and configures a vibration-type force detection sensor. The gap g to electric equivalent resistance Rx (CI) curves shown in FIG. 4 measure the change in the electric equivalent resistance (CI) of the piezoelectric resonator element 10 in air, but may measure in a gas with viscosity such as N₂.

In addition, data processing to determine the force F is easy in a case when the gap g to CI value curve is a straight line, but there is no problem when it is a curve if the reproducibility of the gap g to CI value curve is good. The force F may be determined by the gap g to CI value curve being approximated using a polynomial expression, each coefficient of the polynomial expression being stored in a memory, and each coefficient being referenced from an arithmetic circuit according to requirements.

The operation of the vibration-type force detection sensor 1 will be described. The relationship of the gap g and the CI value and the relationship of the force F and the gap g are measured in advance and made into data for each form of the piezoelectric resonator element 10. Next, as one example, a case where acceleration is measured will be described. When an acceleration α is applied in a +Z axial direction to the vibration-type force detection sensor 1 of FIGS. 1A and 1B, the force F (=m×α where mass m is the sum of the piezoelectric resonator element 10 and the mass portion 20) operates in a −Z axial direction. The gap g between the rear surface of the piezoelectric resonator element 10 and the upper surface 5a of the base 5 becomes narrower due to the force F. The CI value of the piezoelectric vibrator 10 when the force F is not added is set to CI0 and the gap g is set to g0. The CI value of the piezoelectric vibrator 10 when the force F is added is set to CI1. The gap g1 which is equivalent to CI1 is determined using the gap g to CI value curve measured in advance and a force F1 which is equivalent to the gap g1 is determined using a force F to gap g curve. An acceleration α1 is determined using the force F1.

When a force F is added in the +Z axial direction and the gap g becomes wider, the CI value of the piezoelectric vibrator 10 becomes smaller. In order to determine the size of the force F in both of the directions of the +Z axial direction and the −Z axial direction, it is necessary to set the gap g in an appropriate position in the gap g to CI value curves shown in FIG. 4.

Since the vibration-type force detection sensor 1 is a force detection sensor provided with the base 5, the piezoelectric resonator element 10, and the mass portion 20 mounted on a free edge portion of the piezoelectric resonator element 10, there are advantages in that the configuration is simple and low costs are possible. The operation is the gap between the piezoelectric resonator element 10 and the base 5 being narrowed due to a force added to the piezoelectric resonator element, and the electric equivalent resistance CI value of the piezoelectric resonator element 10 changing due to an increase in the resistance of the gas. Since the applied force is determined by the change in the CI value, there is an effect that the response time (measurement time) is fast. In addition, since a counter is not necessary and it is sufficient if the measurement is intermittent measurement, there is an effect that current consumption is small and a reduction in size is possible. Furthermore, since it is sufficient if the piezoelectric resonator element is fixing at one side, and since there is a lower level of influence of heat expansion due to changes in the temperature of the surroundings, there is an advantage that the detection accuracy is high.

Above, the example is shown where the double tuning fork-type crystal resonator element was used in the piezoelectric resonator element 10, but in the piezoelectric resonator element 10, a contoured resonator element which has a vibration portion and a support portion (base portion), for example, a bending resonator element, may be used. In addition, a resonator element with thickness vibration, for example as shown in FIG. 6A, an AT cut crystal resonator element where excitation electrodes 32a and 32b are formed on both surfaces of a piezoelectric substrate 30, for example, an AT cut substrate.

In addition, as shown in FIG. 6B, a surface acoustic wave element (SAW element) may be used where an IDT electrode (inter-digital transducer) and grating reflectors 37a and 37b on both sides thereof are formed along a surface acoustic wave travelling direction on a surface of a surface acoustic vibration substrate 35. However, since the vibration of the surface acoustic wave element is dampened in an inner portion of the substrate and the vibration energy becomes zero in the rear surface, it is necessary to have the surface where the IDT electrode is formed and the surface of the base 5 face each other.

Due to the piezoelectric resonator element 10 using the double tuning fork-type piezoelectric resonator element, the existing manufacturing line using photolithography technology and an etching method can be used. There is an advantage that a reduction in costs of the piezoelectric resonator element can be achieved. In addition, since it is easy for the flexural vibration to be influenced by the viscosity of gas, there is an effect that the change in the CI value is large and the detection sensitivity of the force is improved.

Due to the piezoelectric resonator element 10 using the thickness resonator element, there is an effect that it is possible to configure the vibration-type force detection sensor which is small in size and superior in temperature characteristics and aging characteristics.

Due to the piezoelectric resonator element 10 using the surface acoustic wave resonation element, there is an effect that the supporting of the piezoelectric resonator element is easy and it is possible to mount the mass portion 20 in an arbitrary position where the CI change is large.

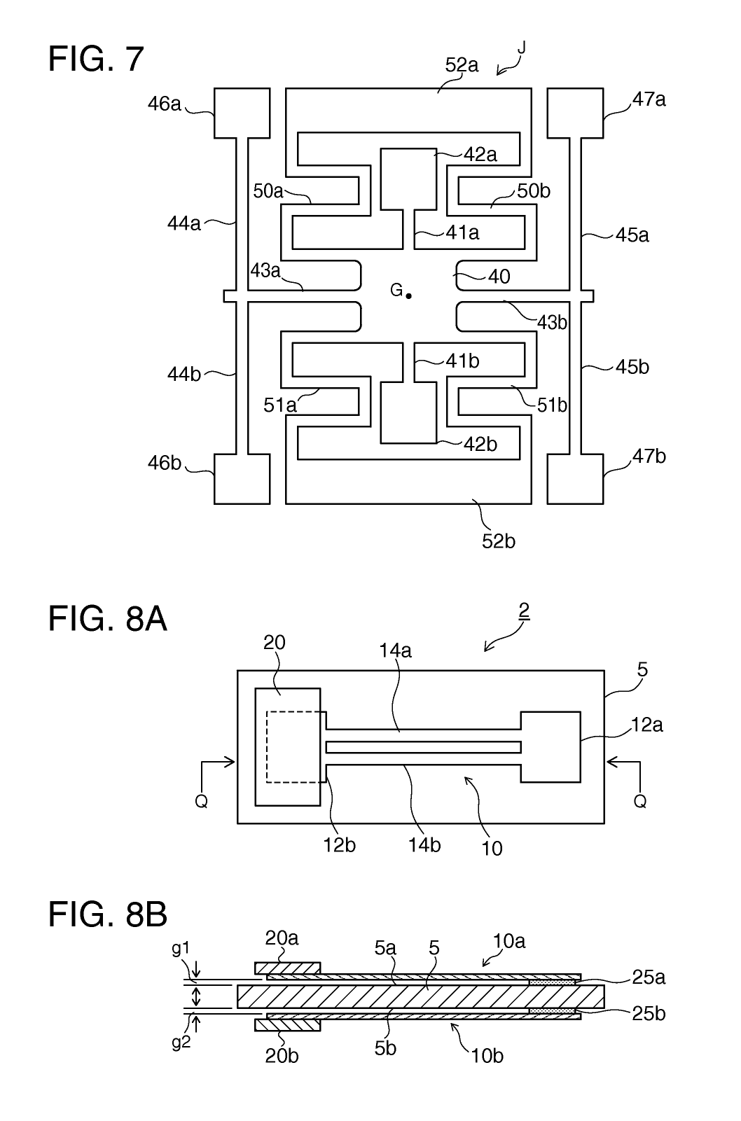

In addition, as the piezoelectric resonator element 10, a vibration gyro element J as shown in FIG. 7 may be used. The vibration gyro element is disclosed in JP-A-2010-2430. FIG. 7 is one example of the vibration gyro element and has a pair of detection vibration arms 41a and 41b which extends in a straight line from a base portion 40 which is centrally positioned to both sides in the up/down direction in the diagram, a pair of connection arms 43a and 43b which extends from the base portion 40 to both sides in the left/right direction in the diagram orthogonal to the detection vibration arms 41a and 41b, left and right pairs of driving vibration arms 44a, 44b, 45a, and 45b which extend from front end portions (vicinity positions) of each of the connection arms 43a and 43b to both sides in the up/down direction in the diagram in parallel with the detection vibration arms 41a and 41b, and at least one out of the four driving vibration arms functions as the piezoelectric resonator element 10 for detecting acceleration. In addition, a detection electrode (not shown) is formed in the surface of the detection vibration arms 41a and 41b, and a driving electrode (not shown) is formed in the surface of the driving vibration arms 44a, 44b, 45a, and 45b. In this manner, a detection vibration system is configured which detects angular speed using the detection vibration arms 41a and 41b and a driving vibration system is configured which drives the vibration gyro element using the connection arms 43a and 43b and the driving vibration arms 44a, 44b, 45a, and 45b.

Furthermore, a pair of beams 50a and 50b are formed with a crank shape (bent shape) which each extend from two corner portions of the upper side of the base portion 40 to both sides in the left/right direction in the diagram orthogonal to the detection vibration arm 41a and which extend in parallel to the detection vibration arm 41a from an intermediate portion, and front ends of the beams 50a and 50b are both connected to a support portion 52a. In the same manner, a pair of beams 51a and 51b are formed with a crank shape (bent shape) which each extend from the other two corner portions of the base portion 40 to both sides in the left/right direction in the diagram orthogonal to the detection vibration arm 41b and which extend in parallel to the detection vibration arm 41b from an intermediate point, and front ends of the beams 51a and 51b are both connected to a support portion 52b.

The vibration gyro element J configures a vibration-type force detection device by being mounted with one of the support portions 52a being support in a cantilever manner on one surface of the base 5 in the same manner as the case of FIGS. 1A and 1B and by combining predetermined circuits such as an oscillation circuit, a filter circuit, a rectification circuit, an integration circuit, or the like.

In a case where the piezoelectric resonator element 10 of the vibration-type force detection sensor 1 shown in FIGS. 1A and 1B uses the vibration gyro element J of FIG. 7, there is an effect that it is possible to configure a composite vibration-type force detection sensor where the driving vibration arms 44a, 44b, 45a, and 45b detect a force applied in the vertical direction of the base 5 and the detection vibration arms 41a and 42b detect the angular speed of rotation in a direction which is parallel to a planar surface of the base 5.

FIGS. 8A and 8B are diagrams illustrating a configuration of a vibration-type force detection sensor 2 according to a second embodiment where FIG. 8A is a planar diagram and FIG. 8B is a cross-sectional diagram along a line Q-Q. The vibration-type force detection sensor 2 is provided with a piezoelectric substrate, piezoelectric resonator elements 10a (10b) where a metallic electrode film is formed on at least one main surface of the piezoelectric substrate, a base 5 which supports the piezoelectric resonator elements 10a (10b) in a cantilever manner and does not move when a force is added, and mass portions 20a (20b) which are each mounted on free edge portions of the piezoelectric resonator elements 10a (10b).

The piezoelectric substrate is provided with vibration portions 14a and 14b (14c and 14d) and support portions 12a and 12b (12c and 12d) which support each of both end portions of the vibration portions 14a and 14b (14c and 14d). In addition, the mass portions 20a (20b) are each mounted on one of the support portions 12b (12d) of the piezoelectric substrate by being adhered and fixed using an adhesive or the like.

The two piezoelectric resonator elements 10a (10b) are each supported in a cantilever manner to be parallel to both main surfaces 5a (5b) of the base 5 via an adhesive which has viscosity so that gaps g1 (g2) between each of the vibration portions 14a and 14b (14c and 14d) and the main surfaces 5a (5b) change and an electric equivalent resistance of each of the vibration portions 14a and 14b (14c and 14d) change when a force acts in a direction orthogonal to both of the main surface 5a and 5b of the base 5.

Both of the piezoelectric resonator elements 10a and 10b are formed of the same material, for example, using a quartz crystal substrate, and in the same shape, and both of the mass portions 20a and 20b are formed of the same material, for example, using a glass material with a high density, and in the same shape.

An operation of the vibration-type force detection sensor 2 of FIGS. 8A and 8B is the piezoelectric resonator elements 10a and 10b both bending downward when a force F which is orthogonal to the main surfaces 5a (5b) of the base 5 is added in a downward manner from above the base 5. As a result, the gap g1 between the piezoelectric resonator element 10a and the upper surface 5a of the base 5 becomes narrower, and the gap g2 between the piezoelectric resonator element 10b and the lower surface 5b of the base 5 becomes wider. That is, the gaps g1 and g2 change oppositely to each other. The method of determining the force from the change in the gaps g1 and g2 is the same as described above. Since the vibration-type force detection sensor 2 is configured with the two piezoelectric resonator elements 10a and 10b being each adhered and fixed to be parallel to both of the main surfaces of the base 5, when a force which is orthogonal to the base 5 is added, the gaps between each of the piezoelectric resonator elements 10a and 10b and the base 5 change so as to be different from each other. That is, when the gap between one of the piezoelectric resonator elements and the base becomes narrower, the gap between the other piezoelectric resonator element and the base changes so as to become wider. It is possible to configure a differential operation of the vibration-type force detection sensor. As a result, there is an effect that the detection sensitivity of the force is doubled and deterioration due to temperature characteristics or aging can be cancelled out.

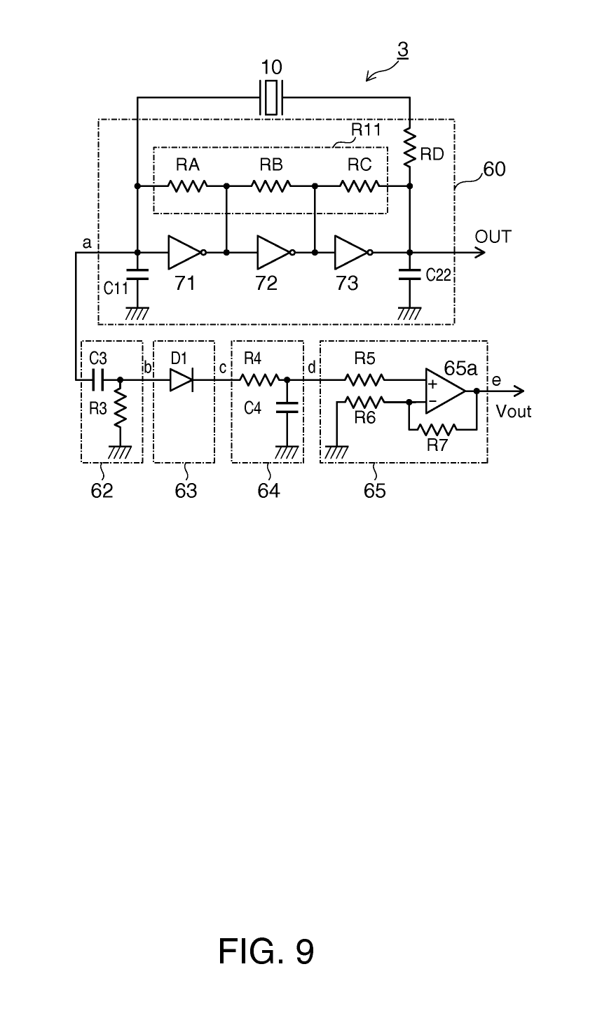

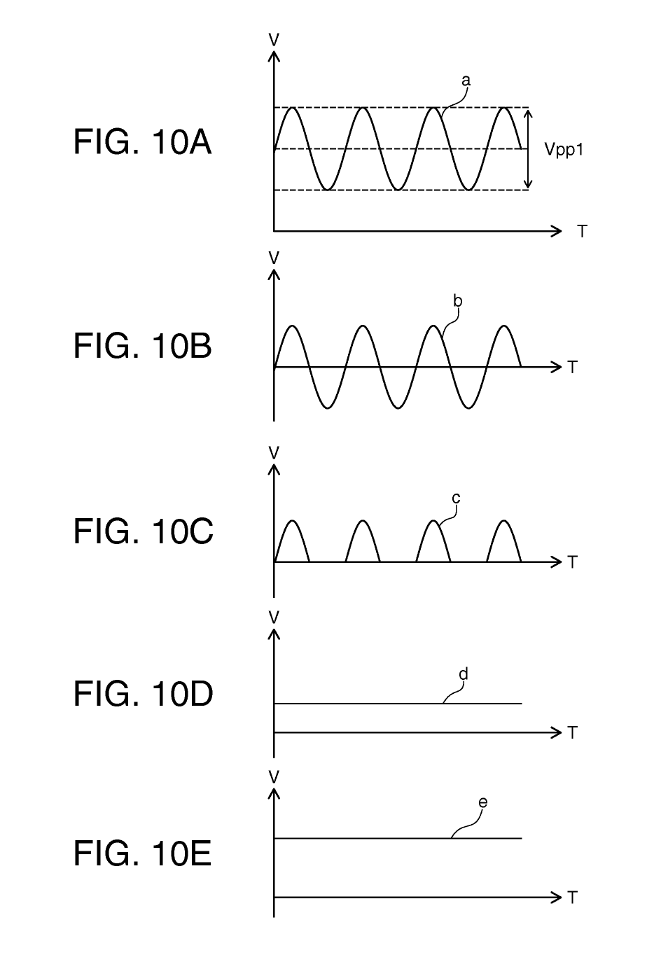

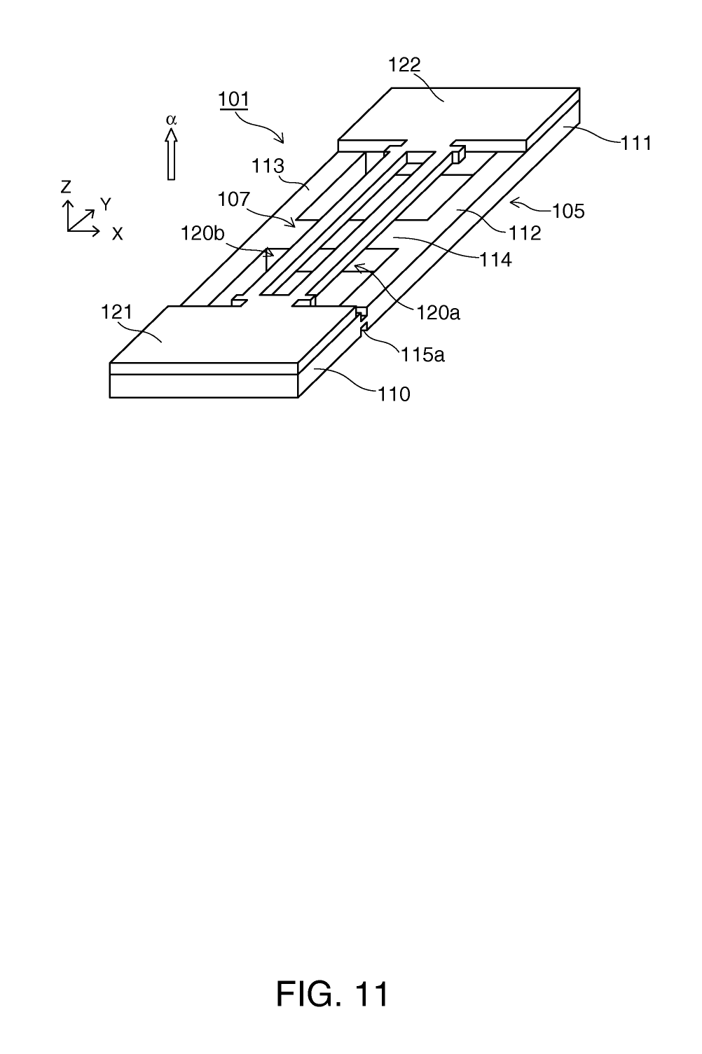

FIG. 9 is a block diagram illustrating a configuration of a vibration-type force detection device 3. The vibration-type force detection device 3 is provided with the vibration-type force detection sensor 1 (2) (J) described above, an oscillation circuit 60, a filter circuit 62, a rectification circuit 63, an integration circuit 64, and a direct current amplification circuit 65. FIGS. 10A to 10E are pattern diagrams illustrating signals of each circuit and the horizontal axis represents time (T) and the vertical axis represents voltage (V).

The oscillation circuit 60 has amplifier inverters 71, 72, and 73 which oscillate the piezoelectric resonator element 10, a resistor R11 which is formed from a circuit where resistors Ra, Rb, and Rc are connected in series, and condensers C11 and C22. A series connection circuit of the inverters 71, 72, and 73 are connected in series between both terminals of the piezoelectric resonator element 10 of the vibration-type force detection sensor.

The input terminal of the first inverter 71 is connected to one of the terminals of the piezoelectric resonator element 10, and the output terminal is connected to the input terminal of the second inverter 72. The output terminal of the second inverter 72 is connected to the input terminal of the third inverter 73. The output terminal of the third inverter 73 is connected to the other terminal of the piezoelectric resonator element 10.

The resistor R11 is connected between both terminals of the piezoelectric resonator element 10. In addition, a terminal of the resistor RA which is a terminal of the resistor R11 is connected to the input terminal of the inverter 71. A terminal of the resistor RC which is the other terminal of the resistor R11 is connected to the output terminal of the inverter 73. A connection midpoint between the resistor RA and a resistor RB is connected to the output terminal of the inverter 71. A connection midpoint between the resistor RB and the resistor RC is connected to the output terminal of the inverter 72. In addition, a resistor RD for phase control is connected between the terminal of the resistor RC which is the other terminal of the resistor R11 and the other terminal of the piezoelectric resonator element 10.

The condenser C11 is connected between the input terminal of the inverter 71 and a ground connection. The condenser C22 is connected between the output terminal of the inverter 73 and a ground connection. According to this, the oscillation circuit 60 outputs an oscillation signal OUT which oscillates the piezoelectric resonator element 10 from the output terminal of the inverter 73.

The filter circuit 62 has a condenser C3 and a resistor R3. One of the terminals of the condenser C3 is connected to the input terminal of the inverter 71 and one of the terminals of the piezoelectric resonator element 10, and the other terminal is connected to the input terminal of the rectification circuit 63. The resistor R3 is connected between the other terminal of the condenser C3 and a ground connection.

As shown in FIG. 10A, the filter circuit 62 inputs as an input signal a signal a which is a portion of the vibrator current as a current output from the terminal connected on the input terminal side of the inverter 71 out of the terminals of the piezoelectric resonator element 10.

Here, the signal a is an alternating current signal with a sine wave where direct current components are overlapped. The amplitude (voltage) Vpp1 of the signal a changes in inverse proportion to the size of the CI value. A large amplitude Vpp1 is output when the CI value is small and a small amplitude Vpp1 is output when the CI value is large.

In addition, as shown in FIG. 10B, the filter circuit 62 removes the direct current component of the signal a and outputs it as a signal b.

The rectification circuit 63 has a diode D1. One of the terminals of the diode D1 is connected to the other terminal of the condenser C3 of the filter circuit 62 and the other terminal is connected to one of the terminals of a resistor R4 of the integration circuit 64. The rectification circuit 63 inputs the signal b output from the filter circuit 62 and a signal c is output where the signal b has been half-wave rectified as shown in FIG. 10C.

The integration circuit 64 has the resistor R4 and a condenser C4. One of the terminals of the resistor R4 is connected to the output terminal of the diode D1 of the rectification circuit 63 and the other terminal is connected to a positive input terminal side of an operation amplifier 65a of the direct current amplification circuit 65. The condenser C4 is connected between the other terminal of the resistor R4 and a ground connection. The integration circuit inputs the signal c output from the rectification circuit 63 and a signal d is output where the signal c has been integrated as shown in FIG. 10D.

The direct current amplification circuit 65 has the operation amplifier 65a and resistors R5, R6, and R7. One of the terminals of the resistor R5 is connected to the other terminal of the resistor R4 of the integration circuit 64 and the other terminal is connected to the positive input terminal of the operation amplifier 65a. One of the terminals of the resistor R6 is ground connected and the other terminal is connected to a negative input terminal of the operation amplifier 65a. One of the terminals of the resistor R7 is connected to the negative input terminal of the operation amplifier 65a and the other terminal is connected to the output terminal of the operation amplifier 65a.

The direct current amplification circuit 65 inputs the signal d output from the integration circuit 64, amplifies the potential of the signal d, and outputs a signal e (Vout) as shown in FIG. 10E.

The vibration-type force detection device 3 can detect a force added to the vibration-type force detection device 3 by detecting the potential of the signal e based on a change in the CI value of the piezoelectric resonator element 10 according to a change in the gap g using the circuit configuration such as that described above. In addition, the detection of the potential of the signal e can be performed in several milliseconds.

In addition, the block diagram of the vibration-type force detection device 3 shown in FIG. 9 is one example and the amplifier of the oscillation circuit 60 is described using an example with 3 steps but 1 step is sufficient or the number of steps may be arbitrarily set according to the design conditions of the oscillation circuit 60. In addition, the direct current amplification circuit 65 is not always necessary. Due to the configuring of the vibration-type force detection device 3 provided with the vibration-type force detection sensor 1 (2), the oscillation circuit 60, the filter circuit 62, the rectification circuit 63, and the integration circuit 64, there is an effect that a device is possible which has a fast response time (measurement time) and a small current consumption, and is small in size at a low cost. In addition, since there is a lower level of influence of heat expansion due to changes in the temperature of the surroundings, there is an advantage that a device with a high detection accuracy is possible.

The entire disclosure of Japanese Patent Application No.2010-097611, filed Apr. 21, 2010 is expressly incorporated by reference herein.

What is claimed is:

1. A vibration-type force detection sensor comprising:
a piezoelectric resonator element provided with a vibration portion where an electrode film is formed on at least one main surface of a piezoelectric substrate and a support portion connected to one end of the vibration portion; and
a base which is provided with one main surface which is connected to the support portion and the piezoelectric resonator element is arranged,
wherein the piezoelectric resonator element is in a state where the other end side of the vibration portion can oscillate so that the size of a gap between the vibration portion and the one main surface changes when a force acts in a direction which is orthogonal with the one main surface of the base, and is supported in parallel with the one main surface of the base so that an electric equivalent resistance of the vibration portion changes according to the change in the size of the gap.

2. The vibration-type force detection sensor according to claim 1, further comprising:
a plurality of the piezoelectric resonator elements,
wherein the piezoelectric resonator elements are provided on the base on each of the one main surface and the other main surface which is at the rear of the one main surface.

3. The vibration-type force detection sensor according to claim 1,
wherein the piezoelectric resonator element is a double tuning fork-type piezoelectric resonator element which is a pair of parallel vibration arms as the vibration portion, one end of the pair of vibration arms is fixed to the support portion, and the other end of the pair of vibration arms is fixed to the support portion, and
a mass portion is arranged in another support portion.

4. The vibration-type force detection sensor according to claim 1,
wherein the piezoelectric resonator element is a thickness resonator element.

5. The vibration-type force detection sensor according to claim 1,
wherein the piezoelectric resonator element is a surface acoustic wave resonation element.

6. The vibration-type force detection sensor according to claim 1,
wherein the piezoelectric resonator element is a vibration gyro element which is provided with a driving vibration arm and a detecting vibration arm for detecting Coriolis force, and the vibration portion is a driving vibration arm.

7. A vibration-type force detection device comprising:
the vibration-type force detection sensor of claim 1;
an oscillation circuit for oscillating the vibration-type force detection sensor;
a filter circuit which attempts to remove a direct current component from an oscillation signal of the oscillation circuit;
a rectification circuit which rectifies an output signal from the filter circuit; and
an integration circuit which integrates an output signal from the rectification circuit.

8. A vibration-type force detection device comprising:
the vibration-type force detection sensor of claim 2;
an oscillation circuit for oscillating the vibration-type force detection sensor;
a filter circuit which attempts to remove a direct current component from an oscillation signal of the oscillation circuit;
a rectification circuit which rectifies an output signal from the filter circuit; and
an integration circuit which integrates an output signal from the rectification circuit.
